(19) United States
(12) Patent Application Publication
(10) Pub. No.: US 2008/0295131 A1
(43) Pub. Date: Nov. 27, 2008

(54) System and method of delivering media content

(75) Inventors: Nancy Grover, San Diego, CA (US); David Crawford Gibbon, Lincroft, NJ (US); Behzad Shahraray, Holmdel, NJ (US); Aleksey Ivanov, Atlantic Highlands, NJ (US); Cynthia Cama, Belmar, NJ (US); Carey J. Joseph, Howell, NJ (US); John J. Brown, III, Flemington, NJ (US); Edward Amoroso, Andover, NJ (US); William A. O'Hern, Spring Lake, NJ (US); Barbara Laing, Colts Neck, NJ (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/805,554

(22) Filed: May 23, 2007

(51) Int. Cl. G06F 3/00

(52) U.S. Cl. 725/39

(57) ABSTRACT

In a particular embodiment, a method of delivering media content in some embodiments includes providing multimedia content from a multimedia delivery service to a customer premises equipment (CPE) device via an access network, wherein the multimedia content includes audio content and video content., the method further includes receiving a request at the multimedia delivery service to provide the multimedia content to a device via a public network and providing the multimedia content to the device via the public network.

### FIELD OF THE DISCLOSURE

The present disclosure is generally related to delivering media content.

### BACKGROUND

Television is a popular form of entertainment. In conventional cable and satellite systems, the subscriber pays for the service of receiving media content at a particular location, such as the home of the subscriber. The service is location specific. However, subscribers often have an interest in viewing media content at other locations. Some major networks offer free video of their broadcasts through the Internet, but the service is limited to the particular network. Hence, there is a need for an improved system and method of delivering media content.

### BRIEF DESCRIPTION OF THE DRAWINGS

FIG. 1 is a block diagram of a particular embodiment of a system of delivering media content;

FIG. 2 is a block diagram of a particular embodiment of a system of delivering media content;

FIG. 3 is a flow diagram of a particular embodiment of a method of delivering media content;

FIG. 4 is a flow diagram of a second particular embodiment of a method of delivering media content;

FIG. 5 is a diagram of a particular embodiment of a graphical user interface to deliver media content;

FIG. 6 is a diagram of a second embodiment of a graphical user interface to deliver media content;

FIG. 7 is a diagram of a third embodiment of a graphical user interface to deliver media content;

FIG. 8 is an embodiment of an Internet Protocol Television system; and

FIG. 9 is a block diagram of a particular embodiment of a general computing system.

### DETAILED DESCRIPTION OF THE DRAWINGS

In a particular embodiment, a method of delivering media content is provided. The method includes providing multimedia content from a multimedia delivery service to a customer premises equipment (CPE) device via an access network. The multimedia content comprises audio content and video content. The method also includes receiving a request at the multimedia delivery service to provide the multimedia content to a device via a public network. The method includes providing the request multimedia content to the device via the public network.

In another particular embodiment, a system includes a first interface to a public network and a second interface to a private access network. The system also includes a subscriber system adapted to manage subscriber accounts. The subscriber system being operable to authenticate a user to access the media content. The media content comprises audio content and video content. The system also includes a media content delivery system responsive to the subscriber system. The media content delivery system being operable to broadcast selected media content to customer premises equipment (CPE) devices of one or more subscribers via the second interface. The media content delivery system is operable to provide the selected media content to a user device via the first interface.

In still another particular embodiment, a method of presenting assets related to media content is disclosed that includes memory that includes instructions executable by the processing logic to perform a method that includes providing multimedia content from a multimedia delivery service to a customer premises equipment (CPE) device via an access network. The multimedia content comprises audio content and video content. The method also includes receiving a request at the multimedia delivery service to provide the multimedia content to a device via a public network and providing the multimedia content to the device via the public network.

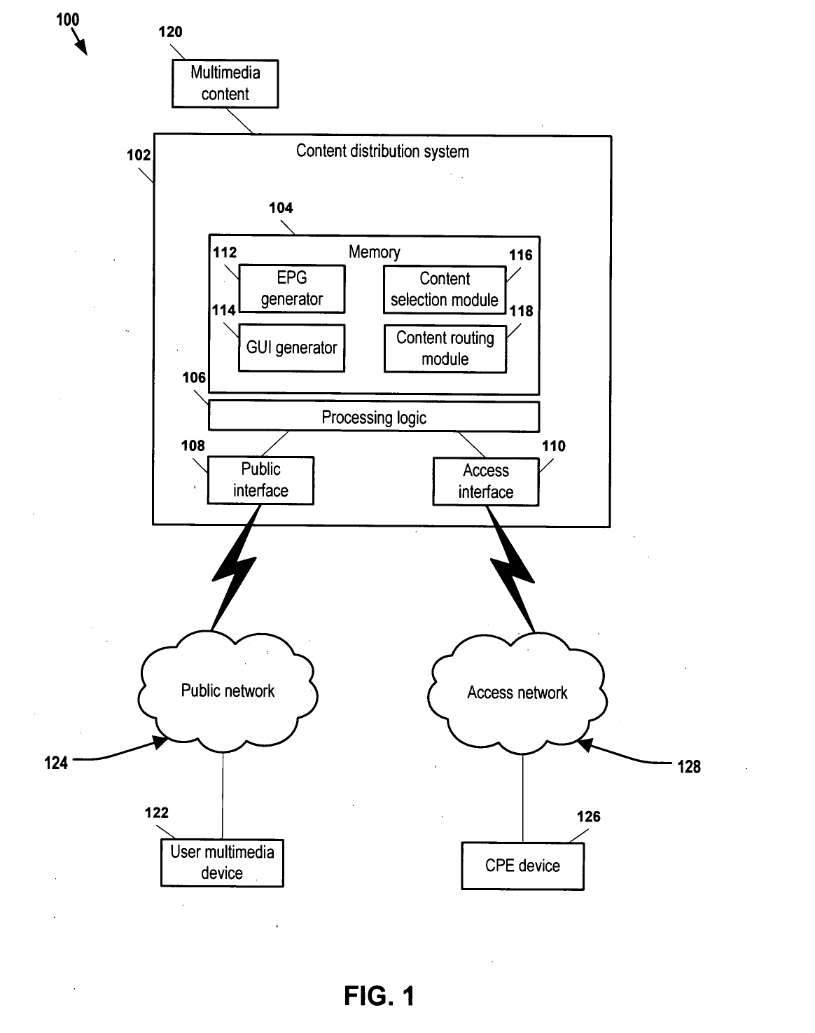

FIG. 1 is a block diagram of a particular embodiment of a system 100 of delivering media content. The system 100 includes a content distribution system 102 that includes a memory 104, processing logic 106, public interface 108, and an access interface 110. The memory 104 includes an electronic program guide (EPG) generator 112, a GUI generator 114, a content selection module 116 and a content routing module 118. The content distribution system 102 receives multimedia content 120, and the processing logic 106 distributes the multimedia content 120 to a user multimedia device 122 via the public interface 108 and a public network 124. The processing logic 106 also distributes the multimedia content 120 to a CPE device 126 via the access interface 110 and an access network 128.

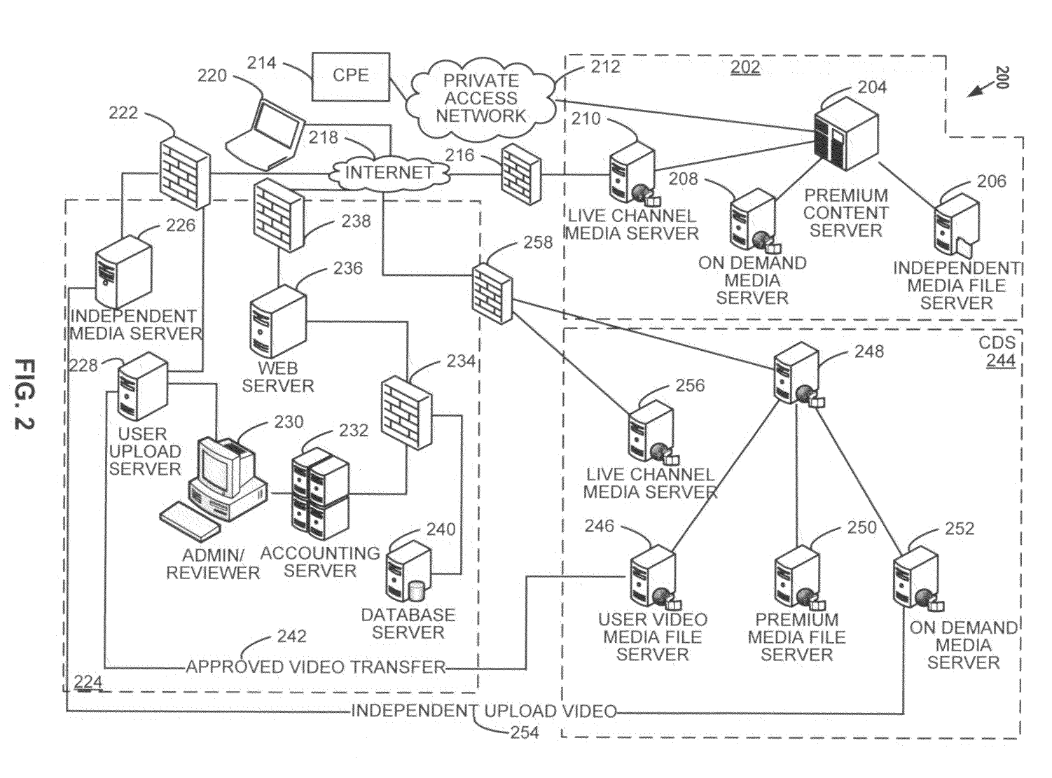

FIG. 2 is a block diagram of a particular embodiment of a system 200 of delivering media content. The system 200 includes a server subsystem 202 that includes a premium content server 204 that communicates with an independent media file server 206 and an on-demand media server 208. The premium content server 204 also communicates with a live channel media server 210. A subscriber subscribes to media content available via the server subsystem 202. The premium content server 204 in the server subsystem 202 communicates via a private access network 212 to a customer premises equipment (CPE) 214. The server subsystem 202 also communicates with a client computer such as laptop 220. In some embodiments, a communication path that includes the firewall 216 and the Internet 218 between the server subsystem 202 and the client computer 220 provides an improved method and means of delivering media content from the server subsystem 202 to a subscriber because the media content services that the subscriber subscribes to at the server subsystem 202 are available at the client computer 220. Moreover, another communication path that includes the private access network 212 between the server subsystem 202 and the CPE 214 provides an improved method and means of delivering media content from the server subsystem 202 to a subscriber because the media content services that the subscriber subscribes to at the server subsystem are available at the CPE 214.

In a particular embodiment, the server subsystem 202 can also communicate with an administrative server subsystem 224 via the Internet 215. The administrative server subsystem 224 includes an independent media server 226 and a user upload server 228 that communicate via the firewall 222. The user upload server 228 communicates with an administrative/reviewer system 230 that communicates with an accounting server 232. The accounting server 232 communicates via a firewall 234 to a web server 236 that communicates to the Internet 218 via a firewall 238. The accounting server 232 also: communicates via the firewall 234 to a database server 240.

In a particular illustrative embodiment, the independent user upload server 228 of the administrative server subsystem 224 communicates via an approved video transfer 242 to an CDS 244 to a user video media file server 246 of the CDS 244. The user video of media file server 246 communicates to an on-demand media server 248, which communicates with a premium media file server 250 and an independent media file server 252. The independent media server 226 of the administrative server subsystem 224 communicates via an independent upload video 254 to the independent media file server 252 of the CDS 244. In some embodiments, a communication path that includes the firewall 222 and the Internet 218 between the CDS 244 and the client computer 220 provides an improved method and means of delivering media content from the administrative server subsystem 224 to a subscriber because the media content services that the subscriber subscribes to at the administrative server subsystem 224 are available at the client computer 220.

The CDS 244 also includes a live channel media server 256 that communicates via a firewall 258 of the administrative server subsystem 224. A communication path that includes the firewall 258 and the Internet 218 between the CDS 244 and the client computer 220 provides an improved method and means of delivering media content from the CDS 244 to a subscriber because the media content services that the subscriber subscribes to at the CDS are available at the client computer 220.

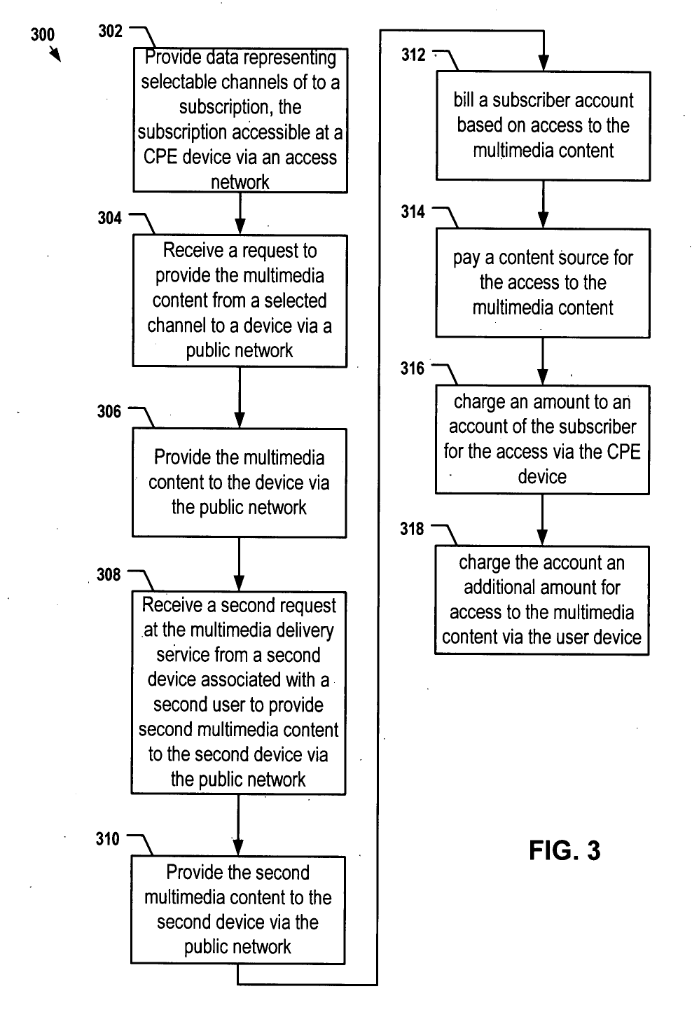

FIG. 3 is a block diagram of a particular illustrative embodiment of a method 300 of delivering media content. At 302, a server system provides multimedia content from a multimedia delivery service to a customer premises equipment (CPE) device. The multimedia content is provided via an access network. The multimedia content comprises audio content and video content. In some embodiments, the multimedia delivery service includes a multiple channel television content delivery service. In some embodiments, the multimedia delivery service includes a first server configured to transmit video data to multiple customer premises equipment (CPE) devices. In some embodiments, the access network comprises an Internet Protocol Television (IPTV) private access network.

Moving to 304, the server system receives a request at the multimedia delivery service to provide the multimedia content to a device via a public network. In some embodiments, the access network and the public network are distinct networks. In some embodiments, the device comprises a computer that has a viewer application configured to receive the multimedia content and in some further embodiments, the method includes providing a video on demand service, wherein at least one video is selectable via the viewer application.

Advancing to 306, the server system provides the multimedia content to the device via the public network.

Continuing to 308, the server system receives a second request at the multimedia delivery service from a second device associated with a second user. The second request provides second multimedia content to the second device via the public network. Moving to 310, the server system provides the second multimedia content to the second device via the public network.

Advancing to 312, the server system bills a subscriber account based on access to the multimedia content. Continuing to 314, the server system pays a content source for the access to the multimedia content.

Moving to 316, the server system charges a first amount to an account associated with the subscriber for access to the media content via the CPE device. Advancing to 318, the server system charges the account an additional amount for access to the media content via the user device.

In some embodiments, method 300 also includes providing an electronic program guide to the device, receiving data related to a selection from the electronic program guide from the device and sending the multimedia content to the device based on the selection via the public network (not shown).

In some embodiments, method 300 also includes verifying that a user that is associated with the first device has subscribed to the multimedia delivery service and sending the multimedia content to the first device in response to verifying the user (not shown).

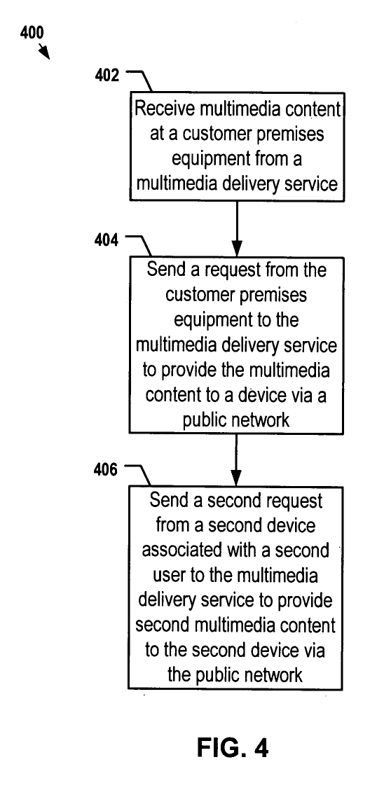

FIG. 4 is a block diagram of a particular illustrative embodiment of a client method 400 of delivering media content. At 402, a destination device such as a set-top box or customer premises equipment (CPE) receives multimedia content from a multimedia delivery service. In a particular illustrative embodiment, the CPE 214 in FIG. 2 receives multimedia content from the premium content server 204.

Moving to 404, the destination device sends a request to the multimedia delivery service to provide the multimedia content to a device via a public network. In a particular illustrative embodiment, the CPE 214 sends the request to the premium content server 204.

Continuing to 406, a second destination device sends a second request that is associated with a second user to provide a second multimedia content to the second destination device via the public network.

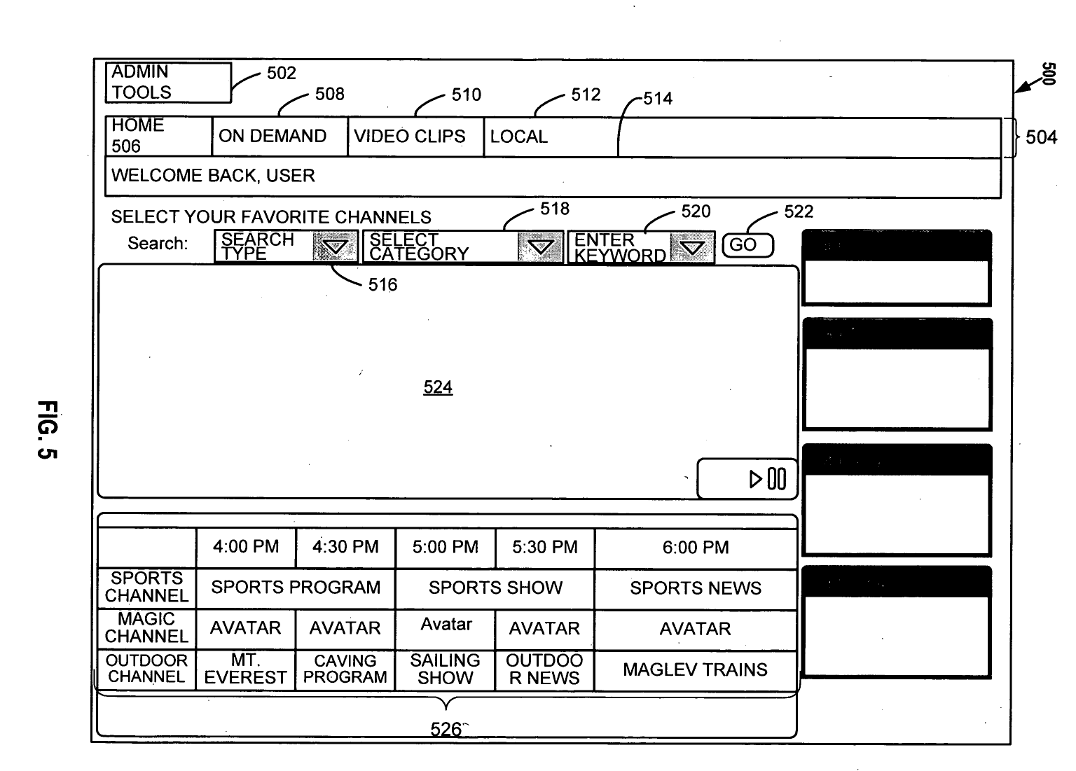

FIG. 5-7 are block diagrams of a particular illustrative embodiment of graphical user interfaces (GUIs) of a video portal in support of delivery of media content.

FIG. 5 is a block diagram of a particular illustrative embodiment of a graphical user interface (GUI) 500 of a main screen of a video portal. The main screen (GUI) 500 provides channel listings, links to on-demand content, links to video clips, links to local content, as well as local weather.

In a particular illustrative embodiment, the main screen (GUI) 500 includes a screen title 502, in this example, “admin tools.”

In a particular illustrative embodiment, the main screen (GUI) 500 includes a title bar that further includes selections for home 506, on-demand 508, video clips 510 and local 512.

In a particular illustrative embodiment, the main screen (GUI) 500 includes message box 514, that displays a current message such as “welcome back, user.”

In a particular illustrative embodiment, the main screen (GUI) 500 includes search drop down boxes to identify channels of particular criteria such as a search drop down box 516 that provides a selectable list of the various search types, a category selection drop down box 518 that provides a selectable list of channel categories, and a keyword selection drop down box 520 that provides an entry box for free-form data, and a button 522 that provides a means to indicate the initiation of a channel search based on criteria specified in one of the drop-down boxes 516, 518 and 520.

In a particular illustrative embodiment, the main screen (GUI) 500 includes display 524 of content from a particular channel.

In a particular illustrative embodiment, the main screen (GUI) 500 includes a program guide 526.

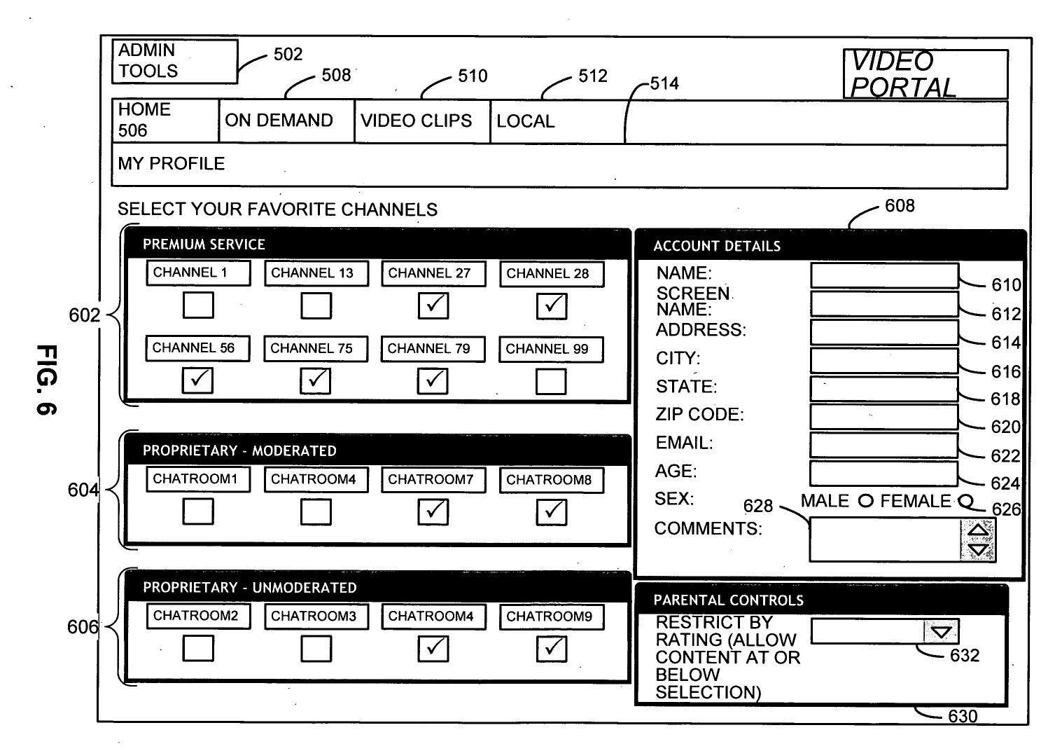

FIG. 6 is a block diagram of a particular illustrative embodiment of a graphical user interface (GUI) 600 of a profile screen of a video portal. The profile screen (GUI) 600 provides a means for users to customize their viewing experience.

In a particular illustrative embodiment, the profile screen (GUI) 600 includes a screen title 502, in this example, “admin tools.”

In a particular illustrative embodiment, the main screen (GUI) 500 includes a title bar that further includes selections for home 506 on-demand 508, video clips 510 and local 512.

In a particular illustrative embodiment, the main screen (GUI) 500 includes message box 514, that displays a current message such as “My Profile”

In a particular illustrative embodiment, the profile screen (GUI) 600 includes a box 602 a user can select premium channels.

In a particular illustrative embodiment, the profile screen (GUI) 600 includes a box 604 in which a user can select proprietary moderated chat rooms.

In a particular illustrative embodiment, the profile screen (GUI) 600 includes a box 606 in which a user can select proprietary, unmoderated chat rooms.

In a particular illustrative embodiment, the profile screen (GUI) 600 includes a box 608 in which the user can enter profile data, such as the name 610 of the user, a screen name 612 of the user, an address 614 of the user, a city 616 of the user, a state 618 of the user, a ZIP code 620 of the user, and e-mail address 622 of the user, an age 624 of the user, a gender 626 of the user, and comments 628 of the user.

In a particular illustrative embodiment, the profile screen (GUI) 600 includes a box 630 in which the user can enter parental control data, such as a drop-down box 632 to specify whether or not multimedia content is to be restricted by rating.

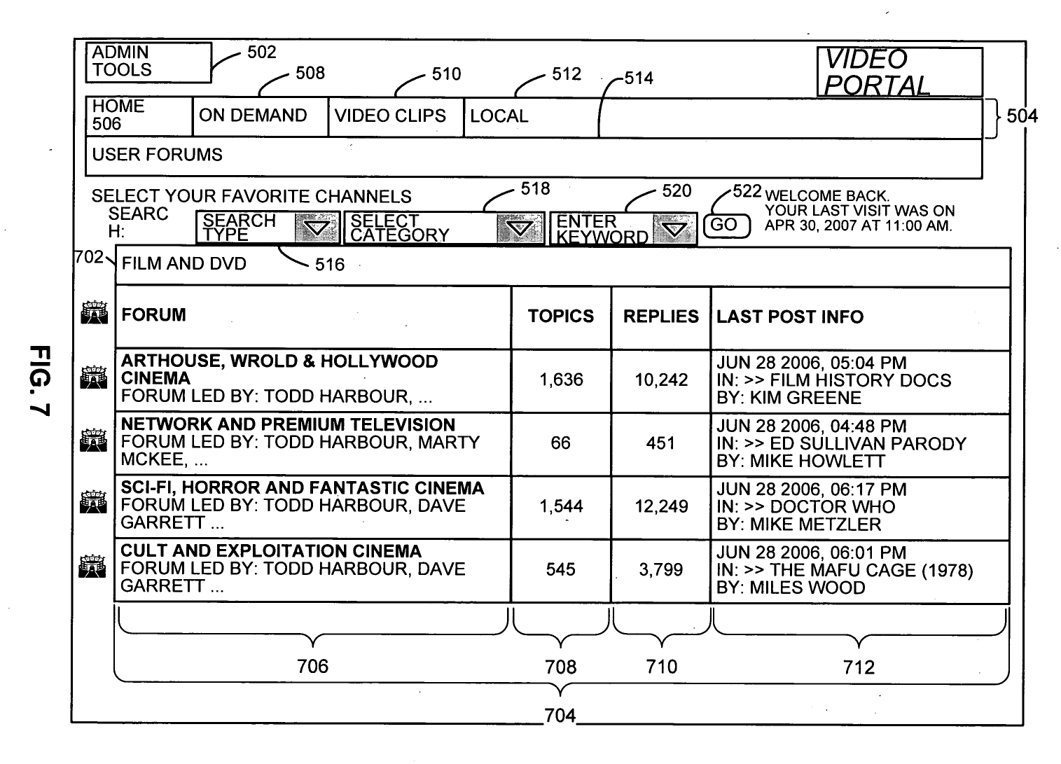

FIG. 7 is a block diagram of a particular illustrative embodiment of a graphical user interface (GUI) 700 of a forum screen of a video portal. The forum screen (GUI) 700 provides a means to select a moderated discussion area.

In a particular illustrative embodiment, the forum screen (GUI) 700 includes a screen title 502, in this example, “admin tools.”

In a particular illustrative embodiment, the forum screen (GUI) 700 includes a title bar that further includes selections for home 506 on-demand 508, video clips 510 and local 512.

In a particular illustrative embodiment, the forum screen (GUI) 700 includes a message box 514 that displays a current message such as “user forums.”

In a particular illustrative embodiment, the forum screen (GUI) 700 includes search drop down boxes to identify channels of particular criteria such as a search drop down box 516 that provides a selectable list of the various search types, a category selection drop down box 518 that provides a selectable list of channel categories, and a keyword selection drop down box 520 that provides an entry box for free-form data, and a button 522 that provides a means to indicate the initiation of a channel search based on criteria specified in one of the drop-down boxes 516, 518 and 520.

In a particular illustrative embodiment, the forum screen (GUI) 700 includes a display box 702 for the general category of forums displayed, such as “film and DVD.”

In a particular illustrative embodiment, the forum screen (GUI) 700 includes a plurality of chat room descriptions 704.

In a particular illustrative embodiment, the chat room descriptions 704 includes a name 706 of the chat room that can optionally include a description of the forum leaders, a quantification 708 of the number of topics in the forum, a quantification 710 of the number of replies in the forum and information 712 on the last post to the forum.

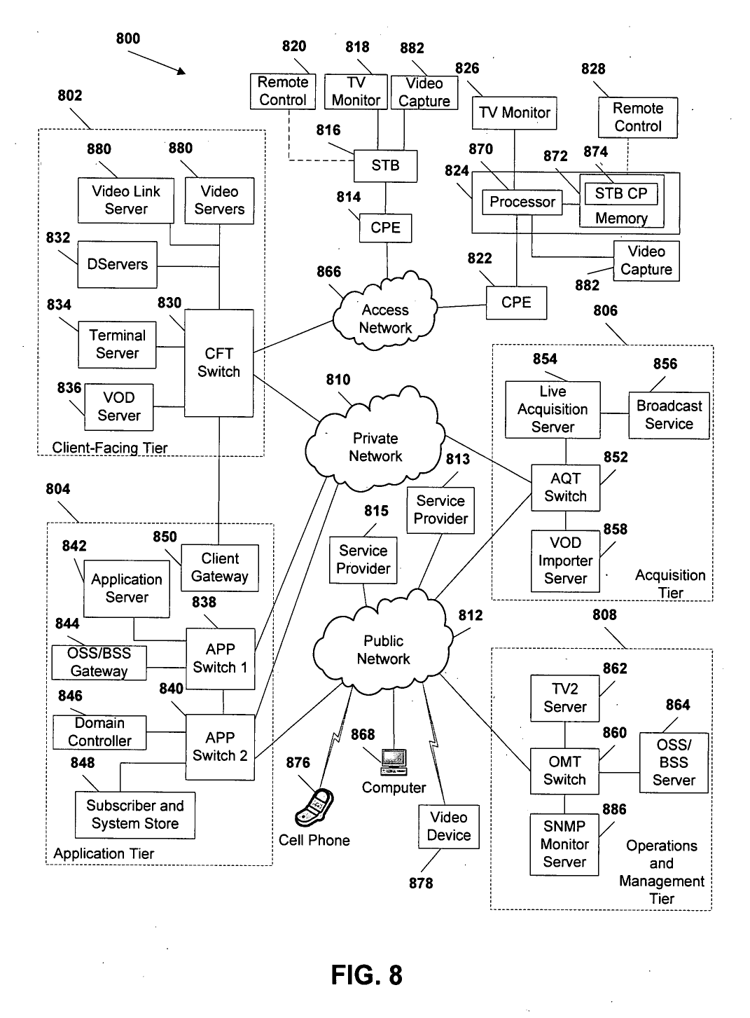

Referring to FIG. 8, an illustrative embodiment of an Internet Protocol Television (IPTV) system that may be used is illustrated and is generally designated 800. As shown, the system 800 can include a client facing tier 802, an application tier 804, an acquisition tier 806, and an operations and management tier 808. Each tier 802, 804, 806 and 808 is coupled to a private network 810; to a public network 812, such as the Internet; or to both the private network 810 and the public network 812. For example, the client-facing tier 802 can be coupled to the private network 810. Further, the application tier 804 can be coupled to the private network 810 and to the public network 812. The acquisition tier 806 can also be coupled to the private network 810 and to the public network 812. Additionally, the operations and management tier 808 can be coupled to the public network 812.

As illustrated in FIG. 8, the various tiers 802, 804, 806 and 808 communicate with each other via the private network 810 and the public network 812. For instance, the client-facing tier 802 can communicate with the application tier 804 and the acquisition tier 806 via the private network 810. The application tier 804 can communicate with the acquisition tier 806 via the private network 810. Further, the application tier 804 can communicate with the acquisition tier 806 and the operations and management tier 808 via the public network 812. Moreover, the acquisition tier 806 can communicate with the operations and management tier 808 via the public network 812. In a particular embodiment, elements of the application tier 804, including, but not limited to, a client gateway 850, can communicate directly with the client-facing tier 802.

The client-facing tier 802 can communicate with user equipment via an access network 866, such as an Internet Protocol Television (IPTV) access network. In an illustrative embodiment, customer premises equipment (CPE) 814 and 822 can be coupled to a local switch, router, or other device of the access network 866. The client-facing tier 802 can communicate with a first representative set-top box device 816 via the first CPE 814 and with a second representative set-top box device 824 via the second CPE 822. In a particular embodiment, the first representative set-top box device 816 and the first CPE 814 can be located at a first customer premise, and the second representative set-top box device 824 and the second CPE 822 can be located at a second customer premise. In another particular embodiment, the first representative set-top box device 816 and the second representative set-top box device 824 can be located at a single customer premise, both coupled to one of the CPE 814 and 822. The CPE 814 and 822 can include routers, local area network devices, modems, such as digital subscriber line (DSL) modems, any other suitable devices for facilitating communication between a set-top box device and the access network 866, or any combination thereof.

In an exemplary embodiment, the client-facing tier 802 can be coupled to the CPE 814 and 822 via fiber optic cables. In another exemplary embodiment, the CPE 814 and 822 can be digital subscriber line (DSL) modems that are coupled to one or more network nodes via twisted pairs, and the client-facing tier 802 can be coupled to the network nodes via fiber-optic cables. Each set-top box device 816 and 824 can process data received via the access network 866, via an IPTV software platform, such as Microsoft® TV IPTV Edition.

The first set-top box device 816 can be coupled to a first external display device, such as a first television monitor 818, and the second set-top box device 824 can be coupled to a second external display device, such as a second television monitor 826. Moreover, the first set-top box device 816 can communicate with a first remote control 820, and the second set-top box device 824 can communicate with a second remote control 828. The set-top box devices 816 and 824 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 816 and 824 can receive data, video, or any combination thereof, from the client-facing tier 802 via the access network 866 and render or display the data, video, or any combination thereof, at the display device 818 and 826 to which it is coupled. In an illustrative embodiment, the set-top box devices 816 and 824 can include tuners that receive and decode television programming signals or packet streams for transmission to the display devices 818 and 826. Further, the set-top box devices 816 and 824 can include a STB processor 870 and a STB memory device 872 that is accessible to the STB processor 870. In one embodiment, a computer program, such as the STB computer program 874, can be embedded within the STB memory device 872.

In an illustrative embodiment, the client-facing tier 802 can include a client-facing tier (CFT) switch 830 that manages communication between the client-facing tier 802 and the access network 866 and between the client-facing tier 802 and the private network 810. As illustrated, the CFT switch 830 is coupled to one or more data servers, such as D-servers 832, that store, format, encode, replicate, or otherwise manipulate or prepare video content for communication from the client-facing tier 802 to the set-top box devices 816 and 824. The CFT switch 830 can also be coupled to a terminal server 834 that provides terminal devices with a point of connection to the IPTV system 800 via the client-facing tier 802. In a particular embodiment, the CFT switch 830 can be coupled to a video-on-demand (VOD) server 836 that stores or provides VOD content imported by the IPTV system 800. Further, the CFT switch 830 is coupled to one or more video servers 880 that receive video content and transmit the content to the set-top boxes 816 and 824 via the access network 866.

In an illustrative embodiment, the client-facing tier 802 can communicate with a large number of set-top boxes, such as the representative set-top boxes 816 and 824, over a wide geographic area, such as a metropolitan area, a viewing area, a statewide area, a regional area, a nationwide area or any other suitable geographic area, market area, or subscriber or customer group that can be supported by networking the client-facing tier 802 to numerous set-top box devices. In a particular embodiment, the CFT switch 830, or any portion thereof, can include a multicast router or switch that communicates with multiple set-top box devices via a multicast-enabled network.

As illustrated in FIG. 8, the application tier 804 can communicate with both the private network 810 and the public network 812. The application tier 804 can include a first application tier (APP) switch 838 and a second APP switch 840. In a particular embodiment, the first APP switch 838 can be coupled to the second APP switch 840. The first APP switch 838 can be coupled to an application server 842 and to an OSS/BSS gateway 844. In a particular embodiment, the application server 842 can provide applications to the set-top box devices 816 and 824 via the access network 866, which enable the set-top box devices 816 and 824 to provide functions, such as interactive program guides, video gaming, display, messaging, processing of VOD material and other IPTV content, etc. In an illustrative embodiment, the application server 842 can provide location information to the set-top box devices 816 and 824. In a particular embodiment, the OSS/BSS gateway 844 includes operation systems and support (OSS) data, as well as billing systems and support (BSS) data. In one embodiment, the OSS/BSS gateway 844 can provide or restrict access to an OSS/BSS server 864 that stores operations and billing systems data.

The second APP switch 840 can be coupled to a domain controller 846 that provides Internet access, for example, to users at their computers 868 via the public network 812. For example, the domain controller 846 can provide remote Internet access to IPTV account information, e-mail, personalized Internet services, or other online services via the public network 812. In addition, the second APP switch 840 can be coupled to a subscriber and system store 848 that includes account information, such as account information that is associated with users who access the IPTV system 800 via the private network 810 or the public network 812. In an illustrative embodiment, the subscriber and system store 848 can store subscriber or customer data and create subscriber or customer profiles that are associated with IP addresses, stock-keeping unit (SKU) numbers, other identifiers, or any combination thereof, of corresponding set-top box devices 816 and 824. In another illustrative embodiment, the subscriber and system store can store data associated with capabilities of set-top box devices associated with particular customers.

In a particular embodiment, the application tier 804 can include a client gateway 850 that communicates data directly to the client-facing tier 802. In this embodiment, the client gateway 850 can be coupled directly to the CFT switch 830. The client gateway 850 can provide user access to the private network 810 and the tiers coupled thereto. In an illustrative embodiment, the set-top box devices 816 and 824 can access the IPTV system 800 via the access network 866, using information received from the client gateway 850. User devices can access the client gateway 850 via the access network 866, and the client gateway 850 can allow such devices to access the private network 810 once the devices are authenticated or verified. Similarly, the client gateway 850 can prevent unauthorized devices, such as hacker computers or stolen set-top box devices from accessing the private network 810, by denying access to these devices beyond the access network 866.

For example, when the first representative set-top box device 816 accesses the client-facing tier 802 via the access network 866, the client gateway 850 can verify subscriber information by communicating with the subscriber and system store 848 via the private network 810. Further, the client gateway 850 can verify billing information and status by communicating with the OSS/BSS gateway 844 via the private network 810. In one embodiment, the OSS/BSS gateway 844 can transmit a query via the public network 812 to the OSS/BSS server 864. After the client gateway 850 confirms subscriber and/or billing information, the client gateway 850 can allow the set-top box device 816 to access IPTV content and VOD content at the client-facing tier 802. If the client gateway 850 cannot verify subscriber information for the set-top box device 816, e.g., because it is connected to an unauthorized twisted pair, the client gateway 850 can block transmissions to and from the set-top box device 816 beyond the access network 866.

As indicated in FIG. 8, the acquisition tier 806 includes an acquisition tier (AQT) switch 852 that communicates with the private network 810. The AQT switch 852 can also communicate with the operations and management tier 808 via the public network 812. In a particular embodiment, the AQT switch 852 can be coupled to a live acquisition server 854 that receives or acquires television content, movie content, advertisement content, other video content, or any combination thereof, from a broadcast service 856, such as a satellite acquisition system or satellite head-end office. In a particular embodiment, the live acquisition server 854 can transmit content to the AQT switch 852, and the AQT switch 852 can transmit the content to the CFT switch 830 via the private network 810.

In an illustrative embodiment, content can be transmitted to the D-servers 832, where it can be encoded, formatted, stored, replicated, or otherwise manipulated and prepared for communication from the video server(s) 880 to the set-top box devices 816 and 824. The CFT switch 830 can receive content from the video server(s) 880 and communicate the content to the CPE 814 and 822 via the access network 866. The set-top box devices 816 and 824 can receive the content via the CPE 814, 822, and can transmit the content to the television monitors 818 and 826. In an illustrative embodiment, video or audio portions of the content can be streamed to the set-top box devices 816 and 824.

Further, the AQT switch 852 can be coupled to a video-on-demand importer server 858 that receives and stores television or movie content received at the acquisition tier 806 and communicates the stored content to the VOD server 836 at the client-facing tier 802 via the private network 810. Additionally, at the acquisition tier 806, the video-on-demand (VOD) importer server 858 can receive content from one or more VOD sources outside the IPTV system 800, such as movie studios and programmers of non-live content. The VOD importer server 858 can transmit the VOD content to the AQT switch 852 and the AQT switch 852 and the VOD import server 858 can communicate the material to the CFT switch 830 via the private network 810. The VOD content can be stored at one or more servers, such as the VOD server 836.

When users issue requests for VOD content via the set-top box devices 816, 824, the requests can be transmitted over the access network 866 to the VOD server 836, via the CFT switch 830. Upon receiving such requests, the VOD server 836 can retrieve the requested VOD content and transmit the content to the set-top box devices 816 and 824 across the access network 866, via the CFT switch 830. The set-top box devices 816 and 824 can transmit the VOD content to the television monitors 818 and 826. In an illustrative embodiment, video or audio portions of VOD content can be streamed to the set-top box devices 816 and 824.

FIG. 8 further illustrates that the operations and management tier 808 can include an operations and management tier (OMT) switch 860 that conducts communication between the operations and management tier 808 and the public network 812. In the embodiment illustrated by FIG. 8, the OMT switch 860 is coupled to a TV2 server 862. Additionally, the OMT switch 860 can be coupled to an OSS/BSS server 864 and to a simple network management protocol (SNMP) monitor 886 that monitors network devices within or coupled to the IPTV system 800. In a particular embodiment, the OMT switch 860 can communicate with the AQT switch 852 via the public network 812.

In an illustrative embodiment, the live acquisition server 854 can transmit content to the AQT switch 852, and the AQT switch 852 and the live acquisition server 854 can transmit the content to the OMT switch 860 via the public network 812. In this embodiment, the OMT switch 860 can transmit the content to the TV2 server 862 for display to users accessing the user interface at the TV2 server 862. For example, a user can access the TV2 server 862 using a personal computer 868 coupled to the public network 812.

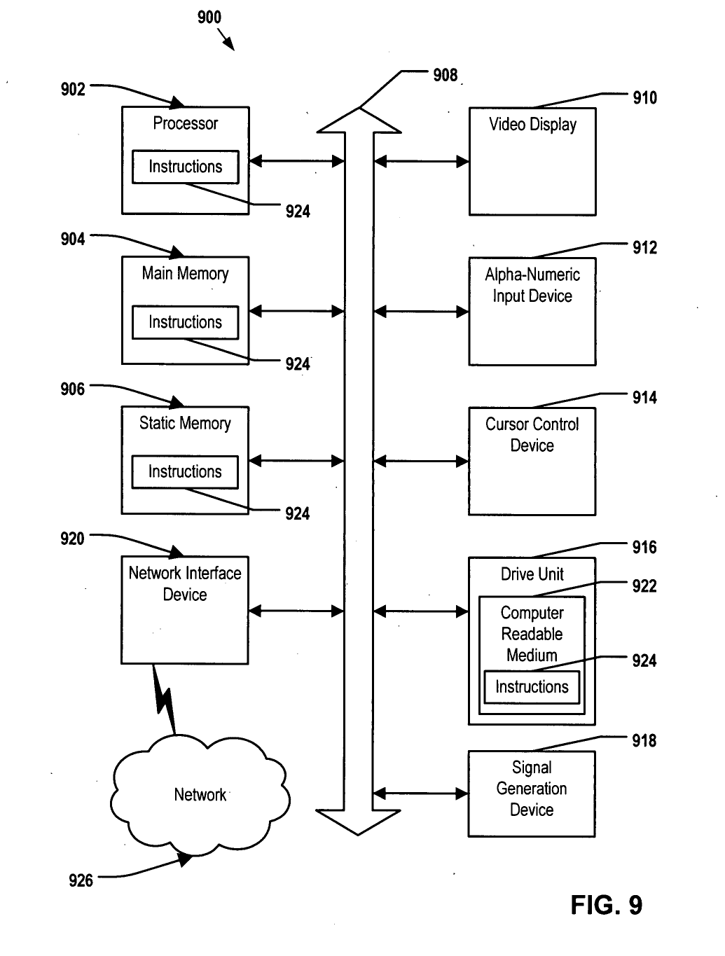

Referring to FIG. 9, an illustrative embodiment of a general computer system is shown and is designated 900. The computer system 900 can include a set of instructions that can be executed to cause the computer system 900 to perform any one or more of the methods or computer based functions disclosed herein. The computer system 900, or any portion thereof, may operate as a standalone device or may be connected, e.g., using a network, to other computer systems or peripheral devices, including a server or set-top box device, as shown in FIG. 8.

In a networked deployment, the computer system may operate in the capacity of an IPTV server, such as a video server or application server, or a set-top box device. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics-processing unit (GPU), or both. Moreover, the computer system 900 can include a main memory 904 and a static memory 906 that can communicate with each other via a bus 908. As shown, the computer system 900 may further include a video display unit 910, such as a liquid crystal display (LCD), an organic light emitting diode (OLED), a flat panel display, a solid state display, or a cathode ray tube (CRT). Additionally, the computer system 900 may include an input device 912, such as a keyboard, and a cursor control device 914, such as a mouse. The computer system 900 can also include a disk drive unit 916, a signal generation device 918, such as a speaker or remote control, and a network interface device 920.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and via the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal, so that a device connected to a network can communicate voice, video or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of delivering media content, the method comprising:
providing data representing a plurality of selectable channels related to a subscription service, the subscription service accessible at a customer premises equipment (CPE) device via an access network, each of the plurality of selectable channels including multimedia content from the subscription service, wherein the multimedia content comprises audio content and video content;
receiving a request to provide the multimedia content from a selected channel of the plurality of selectable channels to a device via a public network; and
providing the multimedia content to the device via the public network.

2. The method of claim 1, further comprising:
providing an electronic program guide to the device;
receiving data related to a selection from the electronic program guide from the device; and
sending the multimedia content to the device based on the selection via the public network.

3. The method of claim 1, wherein the device further comprises:
a computer having a processor coupled to a drive unit

4. The method of claim 1, wherein the access network and the public network are distinct networks.

5. The method of claim 1, wherein the access network comprises an Internet Protocol Television (IPTV) private access network.

6. The method of claim 1 wherein the data is provided by a multimedia delivery service.

7. The method of claim 6, wherein the multimedia delivery service comprises a multiple channel television content delivery service.

8. The method of claim 6, wherein the multimedia delivery service comprises a first server configured to transmit video data to multiple CPE devices.

9. The method of claim 6, further comprising:
receiving a second request at the multimedia delivery service from a second device associated with a second user, the second request to provide second multimedia content to the second device via the public network; and
providing the second multimedia content to the second device via the public network.

10. The method of claim 1, further comprising:
verifying a user that is associated with the device has subscribed to the multimedia delivery service; and
sending the multimedia content to the device in response to verifying the user.

11. The method of claim 1, wherein the device comprises a computer having a viewer application configured to receive the multimedia content.

12. The method of claim 11, further comprising providing a video on demand service, wherein at least one video is selectable via the viewer application.

13. The method of claim 12, further comprising:
receiving data indicating a selection of at least one video from the video on demand service; and
providing the at least one video to the device via the public network.

14. A system comprising:
a first interface to a public network;
a second interface to a private access network;
a subscriber system adapted to manage subscriber accounts, the subscriber system to authenticate a user to access a media content, wherein the media content comprises audio content and video content;
a media content delivery system responsive to the subscriber system, the media content delivery system to broadcast selected media content to customer premises equipment (CPE) devices of one or more subscribers via the second interface, the media content delivery system to provide the selected media content to a user device via the first interface.

15. The system of claim 14, wherein the media content delivery system is adapted to interact with the user device via a browser application and wherein the media content delivery system is adapted to receive data indicating a user selection of the media content via the browser.

16. The system of claim 14, wherein the CPE device comprises a set-top box device adapted to communicate video and audio to a display device.

17. The system of claim 14, wherein the private access network comprises an Internet Protocol Television (IPTV) access network.

18. The system of claim 14, further comprising a targeted advertising system coupled to the media content delivery system, the targeted advertising system to identify targeted advertising content related to an interest of a user associated with the user device, the targeted advertising system to insert the identified targeted advertising content into the media content.

19. The system of claim 14, wherein the identified targeted advertising content includes selectable indicators accessible via an input of the user device.

20. The system of claim 14, further comprising a media server to receive uploaded content from at least one user, the media server accessible by the media content delivery system to distribute the uploaded content to one or more other users via the first interface or the second interface.

21. The system of claim 20, further comprising a staging server to receive the uploaded content and store the uploaded content until approved for distribution.

22. The system of claim 14, further comprising a digital video recorder system to receive a request to record selected media content and to schedule recording of the selected media content.

23. The system of claim 14, wherein the subscriber system is adapted to allow a subscriber to access the media content via the public network and wherein the subscriber does not have access to the media content via the private access network.

24. A server system comprising:
processing logic and memory accessible to the processing logic, the memory comprising instructions executable by the processing logic to perform a method comprising:
providing multimedia content from a multimedia delivery service to a customer premises equipment (CPE) device via an access network, wherein the multimedia content comprises audio content and video content;
receiving a request at the multimedia delivery service to provide the multimedia content to a device via a public network; and
providing the multimedia content to the device via the public network.

25. The system of claim 24, wherein the processing logic is distributed between one or more server devices.

26. The system of claim 24, wherein the method further comprises:
billing a subscriber account based on access to the multimedia content; and
paying a content source for the access to the multimedia content.

27. The system of claim 24, wherein the method further comprises:
charging a first amount to an account associated with the subscriber for access to the media content via the CPE device; and
charging the account an additional amount for access to the media content via the user device.

28. The system of claim 24, wherein the memory further comprises a data storage area accessible by users to store content, the data storage area including a storage area associated with at least one user.

29. The system of claim 28, wherein the method further comprises:
receiving content from at least one user; and
storing the content in the storage area.

30. The system of claim 28, wherein the method further comprises determining a level of access to the content in the storage area based on a subscription of a user.

31. The system of claim 24, further comprising storing a list of related users associated with an account.

32. The system of claim 24, wherein the method further comprises generating a thumbnail image associated with multimedia content.

33. A processor-readable medium having instructions executable by a processor to execute a method comprising:
providing multimedia content from a multimedia delivery service to a customer premises equipment (CPE) device via an access network, wherein the multimedia content comprises audio content and video content;
receiving a request at the multimedia delivery service to provide the multimedia content to a device via a public network; and
providing the multimedia content to the device via the public network.

34. The processor-readable medium of claim 33, further comprising:
storing data related to providing the multimedia content; and
generating an output including statistics based on the data.

35. The processor-readable medium of claim 34, further comprising:
determining advertising content based on the data; and
providing the identified advertising content to the user device.

36. The processor-readable medium of claim 35 wherein the advertising content is provided for display in a browser application.

37. The processor-readable medium of claim 35 wherein the advertising content is provided for display with the multimedia content.
